(19) United States
(12) Patent Application Publication
(10) Pub. No.: US 2018/0075541 A1
(43) Pub. Date: Mar. 15, 2018

(54) System and Method of Financial Reconciliation and Attribution for Businesses and Organizations

(71) Applicant: Jagjit Singh Soni, Centreville, VA (US)

(72) Inventor: Jagjit Singh Soni, Centreville, VA (US)

(21) Appl. No.: 15/816,034

(22) Filed: Nov. 17, 2017

Related U.S. Application Data
(63) Continuation-in-part of application No. 13/776,033, filed on Feb. 25, 2013, now abandoned.
(60) Provisional application No. 61/710,070, filed on Oct. 5, 2012.

(51) Int. Cl. G06Q 40/00; G06Q 20/10

(52) U.S. Cl. CPC G06Q 40/12; G06Q 20/10

(57) ABSTRACT

A disbursement tracking system for organizations, government entities and the like. The system facilitates disbursement of funds to specific recipients within an organization and performs error checking to ensure that only the addressee takes control of the funds. This is accomplished through the creation of an address label which is affixed to the disbursement in the form of an encrypted code, which can be decrypted by a user for storage in a separate disbursement record file containing relevant identifying information. Address label information will include a sender identifier, an address identifier, a disbursement amount, and an optional reference number associated with an allocation or budget proposal. When the disbursement is received by a department or project manager, the system checks the address label against the department's identifier for a match. A correct match results in attribution of the funds to the recipient's available funds total.

### CROSS REFERENCE TO RELATED APPLICATIONS

This application is a continuation-in-part of U.S. patent application Ser. No. 13/776,033 filed on Feb. 25, 2013, which claims the benefit of U.S. Provisional Application No. 61/710,070 filed on Oct. 5, 2012. The above identified patent applications are herein incorporated by reference in their entirety to provide continuity of disclosure.

### BACKGROUND OF THE INVENTION

The present invention relates to systems and methods for tracking disbursements of funds. More specifically, the present invention provides a system and method for tracking the movement and location of funds within an organization and associated organizations using an address label that includes, for example, intended location, actual location, and the destination for a given set of funds for accounting and for reducing the burden of funds reconciliation.

Large organizations and government entities face difficult problems in maintaining proper accounting records. These organizations are often made up of many departments or divisions, each having its own goals, tools, and fiscal concerns.

Bookkeeping for a first department may be simple and only involve procurement of funds for purchase and maintenance of machinery, and meeting payroll. Conversely, another department may have a number of field employees who need per diem allotments, travel reimbursement, conference enrollment costs, and training tuition, in addition to meeting payroll. Another department may have substantial fluctuating research costs including changing personnel, equipment acquisition, laboratory set up, purchase of odd quantities of materials and payroll. Substantial variation in funds usage practices across different sections of an organization makes it impossible for financial overseers to instantaneously determine how much money is spent within the organization.

In most companies or government organizations, accounting is handled by a Chief Financial Officer (CFO) that coordinates with individual departments. Funds are disbursed from the CFO to departments based on proposed budgets or allotments for the previous fiscal period. Each department will generally perform internal accounting to monitor funds usage by individual employees or projects. At the end of a fiscal period the CFO will attempt to reconcile the allotted disbursements with actual expenditures by the department. For larger organizations with many departments, it is extremely difficult to monitor the amount of funds spent and determine whether funds were disbursed correctly.

Another issue that can arise when managing disbursals for many departments is that funds can easily be lost or misappropriated as they make their way down the chain of allotments from the CFO to an individual employee or department. By way of example, an organization may choose to allot one million dollars to a research and development department based on its proposal that it will need one hundred thousand dollars per project for ten projects. The CFO makes this allotment and disburses the funds to the research and development department. But, when the department receives notice of the allotment, it realizes it only needs fifty thousand for one project and decides to split the leftover money and give it to two other projects. The next fiscal period, research and development submits a proposal for another one million dollars but this time the proposal is based on usage for the prior fiscal period, i.e., fifty thousand dollars for one project, one hundred twenty-five thousand dollars for two projects, and one hundred thousand dollars for seven projects. While this proposal appears to be a fair and honest representation of expenditures, it will not match up with the CFO's records of allotments for the prior fiscal period. Reconciliation discrepancies such as this, though non-criminal, require a long time to correct, which wastes time, money, and resources of the company while the mystery is solved.

Current accounting systems log allotments and disbursement and then try to match them up with expenditures. Discrepancies can only be reconciled if an individual or group of individuals conducts a careful investigation of the chain of custody associated with a disbursement. This is time-consuming, and may end up costing more in the amount the company pays the investigator than the discrepancy is worth. Further, some reconciliation problems simply cannot be solved because there is no record of where the money actually went, or how it was spent on a particular project. In light of the above concerns and issues that arise from known methods of tracking disbursals, it is desirable to provide a system that automatically tracks and logs disbursements as they move through the organization while error checking for incorrect disbursals, ensuring that funds reach their target destination

### SUMMARY OF THE INVENTION

In view of the foregoing disadvantages inherent in the known types of funds tracking systems now present in the prior art, the present invention provides a new disbursement tracking system, wherein the same can be utilized for providing convenience for the user when reconciling accounting discrepancies. The disbursement tracking system includes a processor, a non-transitory computer readable medium operatively connected to the processor, and a logic stored in the non-transitory computer readable medium that, when executed by the processor, causes the disbursement tracking system to perform a method. The method includes: receiving a disbursal request from an administrator interface, the disbursal request including an address label that includes sender identifier, an addressee identifier, and a disbursal amount; transmitting the disbursal request to a recipient via a network, the selection of the recipient and the transmission of the disbursal request corresponding to one or more budget parameters stored in the non-transitory computer readable medium; comparing the addressee identifier to a plurality of recipient identifiers stored in the non-transitory computer readable medium, each recipient identifier corresponding to individual recipients, each individual recipient corresponding to a department in an organization; if the addressee identifier matches the recipient identifier, then disbursing the disbursal amount to the recipient and modifying the one or more budget parameters based on the disbursal amount; if the addressee identifier does not match the recipient identifier, then displaying a failed delivery notice on the administrator interface, and storing the failed delivery notice in the non-transitory computer readable medium.

Disbursement recipients can redistribute funds to individuals within their sub-organization. Department heads can thus distribute a portion of their budget to various projects, per diems, travel expenses, material acquisitions, and individuals as necessary. The funds expenditures attributed to each terminating point in the chain of custody can be tracked back up to the CFO, making reconciliation easy and inexpensive.

It is therefore an object of the present invention to provide a new a disbursement tracking system that solves the problems in the field of instantaneously determining whether a disbursal is correct, as well as instantaneously updating information relating to an organization's budget and expenditures in a central location accessible by approved users within the organization.

It is another object of the present invention to provide a system that allows for instantaneous and continuous tracking of funds allocations and disbursements from the initial disbursement down to the final recipient.

Another object of the present invention is to provide a system that provides easy reconciliation of expenditures to the original budget allocations on a single platform.

Still another object of the present invention is to provide a system that prevents disbursements from being misappropriated and logs when a disbursal error occurs.

Yet another object of the present invention is to provide a system that ensures funds are attributed only to the intended recipient.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a system diagram of a first embodiment of the disbursement tracking system.

FIG. 2 shows a system diagram of a second embodiment of the disbursement system.

FIG. 3 shows a flow diagram of a sample transaction made within the disbursement system.

FIG. 4 shows a flow diagram of the disbursement initialization and transmission process.

FIG. 5 shows a flow diagram of an alternative embodiment of the disbursement initialization and transmission process.

FIG. 6 shows a flow diagram of an embodiment of the address label error checking process.

FIG. 7 shows a flow diagram of an embodiment of the attribution process.

FIG. 8 shows a flow diagram of an alternative embodiment of the address label error checking and attribution processes.

FIG. 9 shows a flow diagram of an alternative embodiment of the address label error checking and attribution processes.

### DETAILED DESCRIPTION OF THE INVENTION

Reference is made herein to the attached drawings. Like reference numerals are used throughout the drawings to depict like or similar elements of the disbursement tracking system. For the purposes of presenting a brief and clear description of the present invention, the preferred embodiment will be discussed as used for instantaneously determining and storing the validity of expenditures and allocations within organizations. The figures are intended for representative purposes only and should not be considered to be limiting in any respect.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

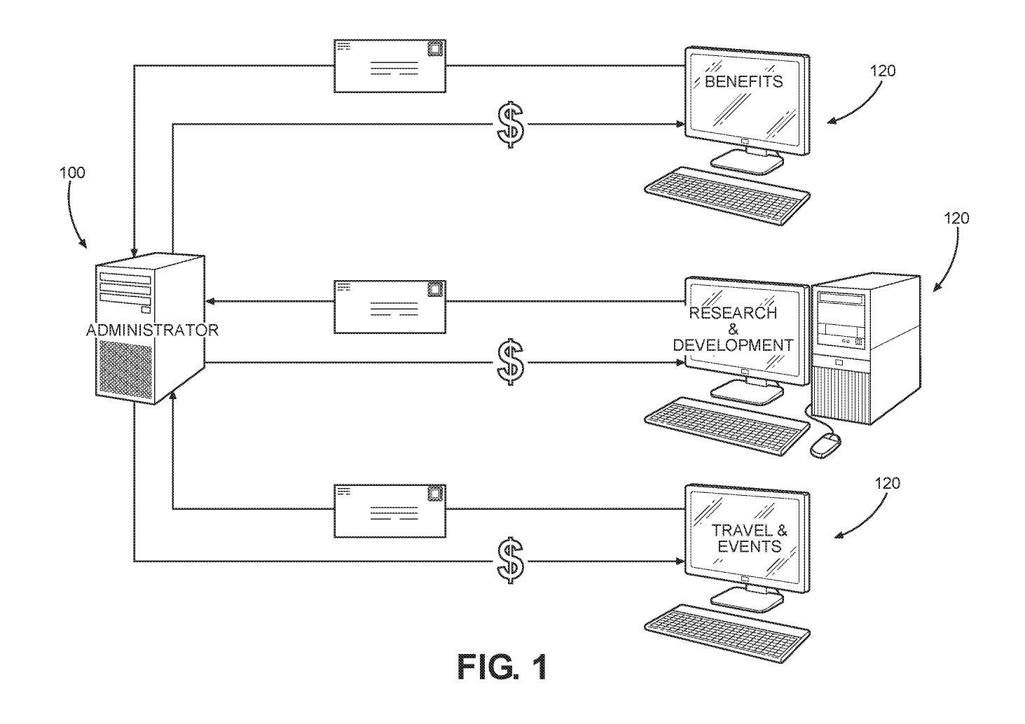

Referring now to FIG. 1, there is shown a diagram of a disbursement tracking system. The system provides a means for government entities, corporations, large charities, and other organizations to reconcile budget allotments with expenditures by automatically error checking disbursements and logging all disbursements so that the location of the individual funds can be determined at any time. Disbursements made by the Chief Financial Officer (CFO), Bursar, Comptroller, or other financial officer are directed to specific recipients within an organization. An administrator interface 100 is used to create and disburse funds to departments 120 based on the organization's budget parameters. The administrator interface 100 may include a processor, a non-transitory computer readable medium operatively connected to the processor, and a logic stored in the non-transitory computer readable medium that, when executed by the processor, causes the system to perform its essential functions. Each department 120 is identified within the system as a possible addressees or recipients of funds. When the administrator 100 initiates a disbursal, the disbursal is transmitted to a recipient via a network, such as the internet or a local area network, for example. The system is configured to log the transmission and receipt of funds allocations and ensures that they are attributed to the proper departments, while automatically updating a database of transactions and disbursements. The present system is somewhat analogous to a package tracking system, in that the automated generation of identifying information functions similarly to an address label for disbursements, wherein the system analyzes the identifying information of each disbursal, checks for proper delivery, and stores the success or failure of the deliver, as well as sending notice to the sender of delivery failure or confirmation.

Administrative users enter organizational budget parameters into the administrator interface either by manual input or by automatic importation of budget proposal files from departments, which may include expenditure projections for a given financial period. They will generally include estimates on payroll expenses, major projects, and equipment purchases, as well as slush fund costs. Each financial period, proposals are submitted to the appropriate organizational authority for approval.

In the present system, the budget is approved within the administrator interface and the system then automatically records the information to a budget database. Information on proposed expenditures of each department is then available to the administrator or other approved users for look-up. The decision to limit budget information to overall expenditures of projects/employees or to monitor individual purchases is up to the organization, and the system contemplates both accountability depths. The budget parameters provide guidelines for when and to whom disbursals should be made, and can be automatically imported into particular disbursal requests. In one embodiment, the system may be configured to automatically update budget parameters based upon correct or incorrect disbursals. The budget parameter updating can be automatic or can require approval from the CFO or another authorized administrator.

Once budgeting parameters for a financial period is formalized by the organization's CFO, funds can be allocated from the organization's budget to each department according to their budget proposals. In some organizations, disbursements are made only as needed, to facilitate proper correlation between disbursements and expenditures. This technique attempts to match up proposed events with end results, without accountability for interim events. Conversely, the present system is configured to release funds only upon assurance of proper delivery to a specific recipient, based on specific proposals. Because the system checks receipt and logs attribution at each step of the fiscal chain of custody, a transaction history is automatically created and maintained for each disbursement, making reconciliation easy.

The present disbursement system accomplishes this by creating an “address label” for each disbursement. Address labels may be separate files, or bit patterns concatenated to the disbursement transaction file itself. Identifying information about the sender, general recipient, amount, and optionally a specific recipient and budget proposal identifier, will be included in the address label. An administrator will input this information, or it can be imported automatically from the budget database during disbursement initialization.

Unique recipient identifiers are assigned to each department and sub-unit within the organization so that senders and addresses can be easily associated with particular departments. Some organizations may hold only one or a couple bank accounts, for general organizational use as filtered by the financial officer. Others may have individual accounts for each department, and shift funds into these accounts as necessary. Under the present system, each entity that may receive a disbursement is given a recipient identifier.

In FIG. 1, the system is shown in an organization that employs one or a couple of general accounts. Because the funds are in a pool, there is no need for actual shifting of funds between the organization's accounts. Thus, all disbursement transactions happen within the disbursement tracking system. Funds disbursements are initiated, address labels created, and the funds are “sent” to their addressees. The system is configured to automatically notify the financial officer of proper or improper receipt and attribution, as well as update the stored transaction record, providing for consistent and automatic recordkeeping for accounting and reconciliation purposes.

Each department is responsible for ensuring that their disbursements match with individual purchases. This is easily done within the client interface which can be used to provide the system with an input of individual expenditures and which prompts the user to designate the disbursement pool used. A disbursement pool identifier may be stored in the non-transitory computer readable medium to facilitate the designation. In some embodiments of the system, permission must be given from the CFO or other administrator before funds can be transferred from one pool to add to another. In this way, companies can easily and instantaneously track funds as they are transmitted and divided amongst individual projects and teams of employees, making it easy to figure out who is responsible for discrepancies, and thus easier to sort inconsistencies out.

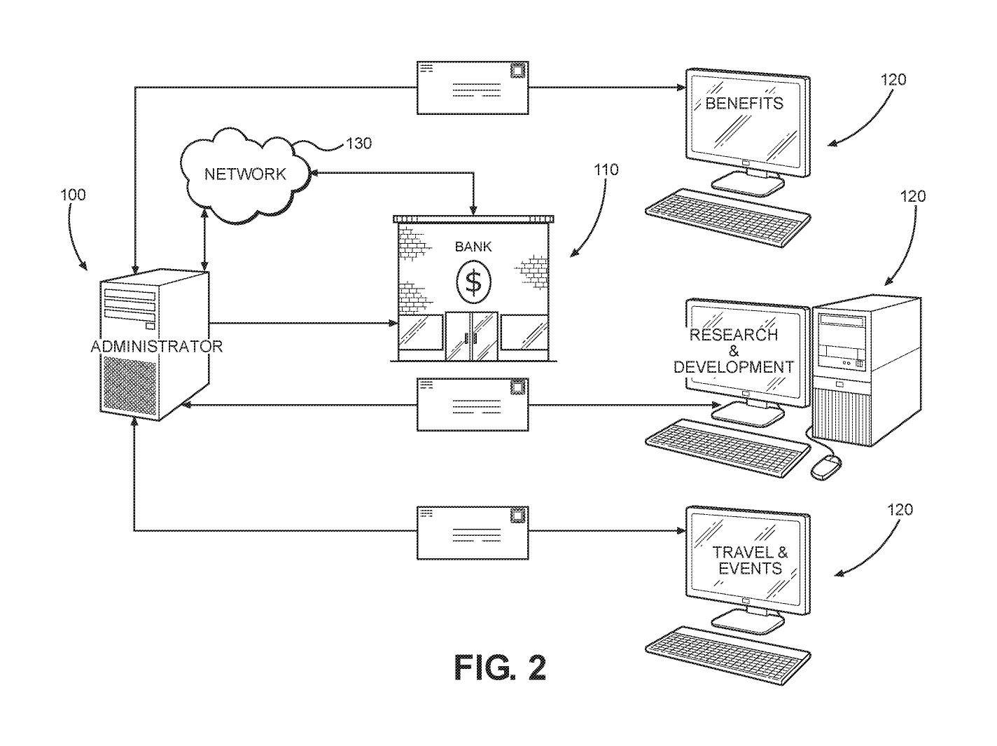

Turning to FIG. 2 there is shown a diagram of the disbursement system at an organization that employs diversified bank accounts. Because money must actually be shifted between accounts during disbursals, a financial institution 110 is contacted via the a network 130 such as the internet or another network. Once the financial officer initiates a disbursement, the system automatically creates an address label and transmits the disbursement via the administrator terminal 100, whereby the address label is sent to the addressee department 120, project, or individual. Upon receipt by the client interface, the system automatically checks to ensure that the addressee matches the recipient before attributing the funds. If attribution is achieved, the bank is given an electronic funds transfer request to shift the actual funds between accounts. In some embodiments, a second error checking may be used to ensure that the funds were properly transferred. Notice will be send to the sender and stored for later access, providing delivery confirmation. In some embodiments, a bank transaction history and a delivery history will be maintained in a transaction database to assist in reconciliation. The timing of the address label error checking and electronic funds transfer process will be discussed in detail below, and can happen in multiple embodiments.

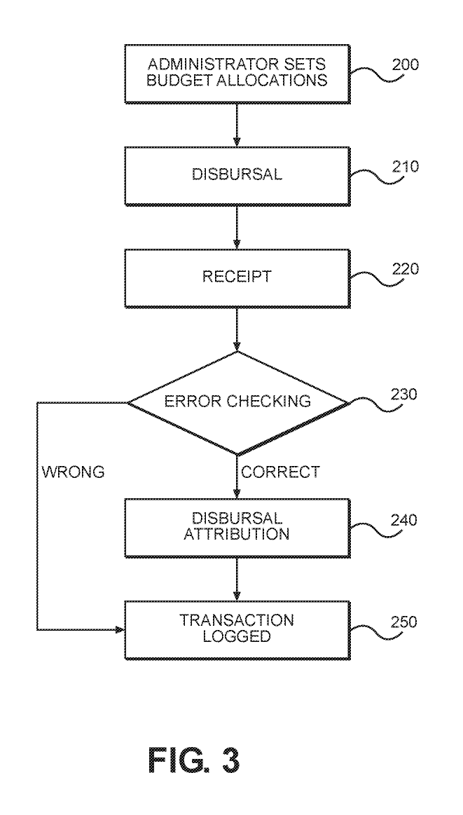

Referring now to FIG. 3, there is shown flow chart of the overall process occurring between disbursement creation and attribution. First, the CFO or other administrator builds a budget for the financial period 200, the budget parameters of which are based on proposals of various departments. The system is configured to cause disbursals to be automatically made 210 to different departments at pre-determined times. For example, pay roll may be released once a month, equipment acquisition funds may be disbursed upon ordering of machinery, and so on. When the disbursal is initialized, the administrator will input the unique identifier of the sender, the unique identifier of the recipient(s), amount of disbursal, and any identifiers associated with a particular project, allocation, or budget proposal. The system then compiles the above information and attaches the information to the disbursal request as an address label. Then, the funds are sent to the address on the disbursement address label.

In some embodiments of the invention, the system is configured to store received disbursements in a “mailbox””, which is a directory used for temporary storage of pending disbursements. Once the disbursement is received by the address 220 it will be held in the mailbox associated with the department until proper delivery is confirmed. This error checking process 230 may happen automatically, as soon as new files appear in the mailbox, or upon user input. Automatic processing is preferred; however some organizations may desire that an employee acknowledge receipt of the funds, similar to signing for a package.

In some embodiments of the invention, the system is configured to perform error checking 230 via the client interface. When a disbursement is received in the mailbox, or when a user acknowledges receipt, the system is configured to analyze the address label information and attempt to match the addressee identifier with the identifier of the actual recipient. Each mailbox is associated with a particular organizational identifier so that the system can easily determine where a disbursement has been received. If the recipient identifier does match the addressee identifier as disclosed by the address label, the funds are added to the recipient's available funds balance 240. A delivery confirmation is added to the transaction database in the form of a disbursement log entry 250. Notice of delivery can optionally be sent to the sender, if redundant recordkeeping is desired.

If the identifiers do not match, no funds are attributed to the user's available funds balance. Notice is sent to the sender that delivery failed, and further action is prompted. A record of the incorrect delivery is added to the transaction database as a disbursement log entry 250. The system may automatically correct the address label based on stored parameters so that the address identifier matches that of the recipient, or may cancel the disbursement all together and create a new one addressed to the appropriate party. Alternatively, the CFO can manually cancel the request and initiate a new one.

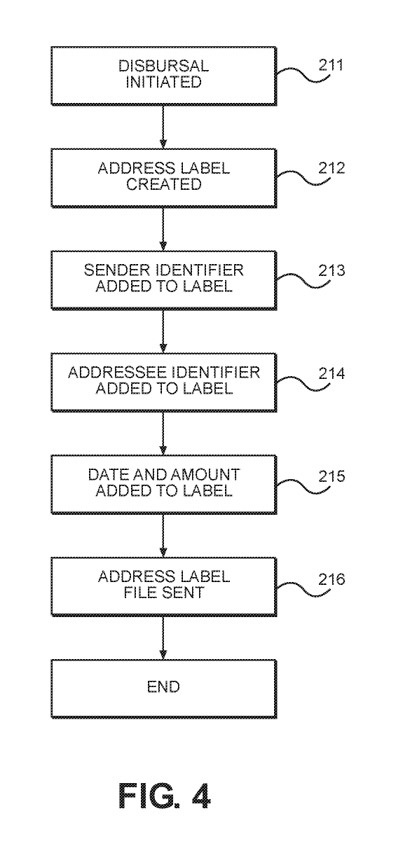

Referring now to FIG. 4, there is shown a detailed flow diagram of the disbursal process. The system is configured to initiate 211 a disbursal after receiving an input from an administrative user such as a member of the CFO staff. The administrative user interacts with the administrator interface in such a way as to cause the system to create a new disbursement record. Basic information about the disbursal is entered or selected from on-screen representations of budget database entries. The date, amount of disbursal, intended recipient, sub-organizational information, and associated allotment information are added to the new disbursement record.

Once all initial disbursement information is entered, the system creates an address label 212. This may involve the generation of a new data file, or may involve the addition of a string of characters to the beginning of the disbursement record file. In a preferred embodiment, the address label is a string of characters inserted at the beginning of the disbursement record data file. This embodiment reduces the number of files that must be stored and tracked. Only one file must be sent at a time, which also reduces the likelihood of improper delivery of one of the two files, but not the other.

The administrator interface adds the sender's unique organizational identifier to the address label 213, then adds the addressee's unique organizational identifier 214, and lastly adds the date and disbursal amount 215 along with any other desired information. It is essential that this information is added in the same order to each address label. If contiguous information parcels are delineated, they must be delineated in the same manner in each address label. For example, the string “001-123-01012001-800000.00” could designate that the administrator's office, identified as 001, is sending the marketing department, identified as 123, money on Jan. 1, 2001, in the amount of 800,000.00. All address labels within this organization will have the format “senderID-addresseeID-mmddyyyy-amount.” Delineations need not be used so long as order of information chunks is strictly observed.

The address label is then finalized and sent to the addressee 216. In one embodiment, this involves the transmission of the disbursement record with the address label inserted at the beginning of the file. In the alternative embodiment, the address label file is sent separate of the disbursement record, and the disbursement record is not attributed until the address label is checked by the system for proper delivery.

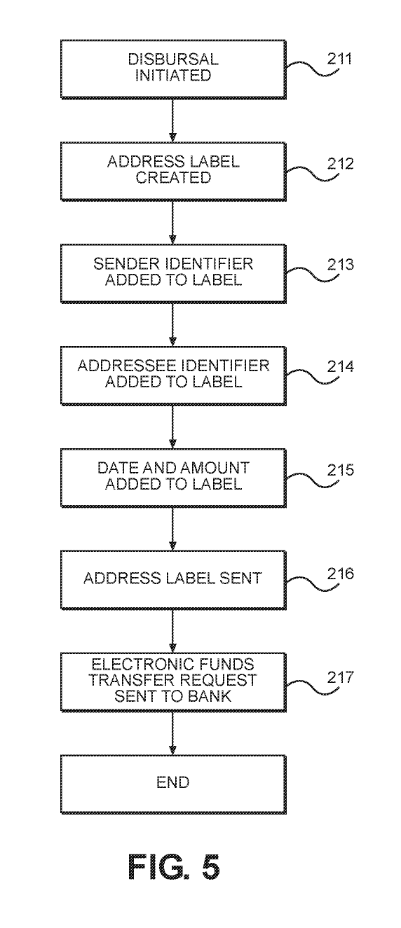

Referring now to FIG. 5, there is shown an alternate embodiment of the disbursal process. This flow diagram illustrates how an outside financial institution is incorporated into the disbursal. It is used in embodiments of the system where the organization utilizes multiple bank accounts that are associated with individual departments. A disbursal 211 is initiated in the same manner as described above, and an address label similarly created 212. The sender's unique identifier is added to the label 213 as is the addressee's identifier 214, the date, amount and any other information 215. Once this is finalized, the address label is transmitted to the addressee 216. At the same time the address label and/or disbursement record are transmitted, the system is configured to initiate an electronic funds transfer request 217 to the outside financial institution. The funds transfer requests that money be moved from the sender's bank account to the addressee's. To facilitate this request, bank accounts are stored within the system and associated with unique identifiers of departments. In this way, the creation of an address label also includes the query of the system for bank account information associated with the sender and the addressee.

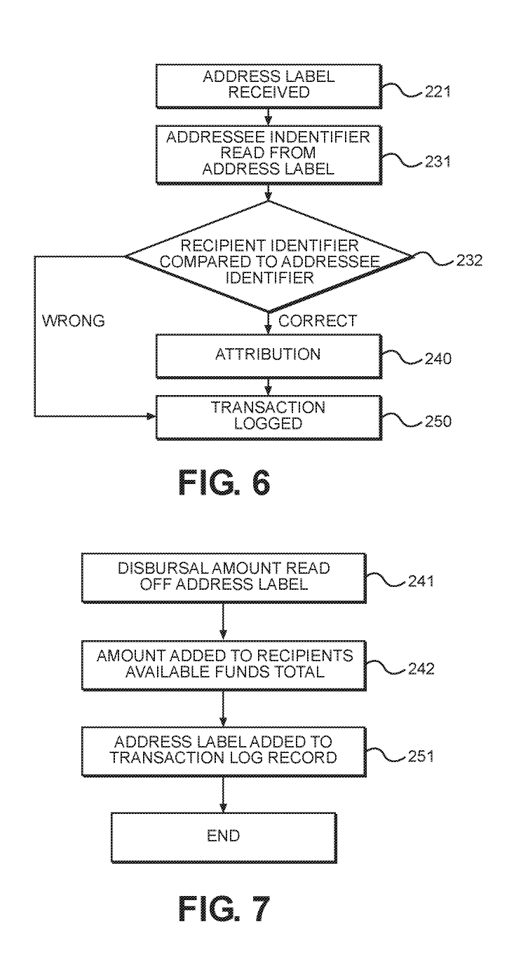

Referring now to FIG. 6, there is shown an embodiment of the error checking process. This process is utilized in the embodiment of the system that does not require interaction with an outside financial institution. Address labels are received 221 into the mailbox of the addressee as determined by the addressee identifier indicated on the address label. When the address label is sent, the system automatically correlates the address identifier with a department and automatically sends the file to that department's recipient mailbox. The system is further configured, by way of the recipient's client interface, to read the addressee identifier of the address label file 231. The system is configured to compare the addressee identifier with the actual recipient's identifier 232 to determine if a match exists. If the identifiers are the same, then the funds are attributed to the recipient's available funds balance 240. If there is no match, the sender is notified of the delivery failure, and the transaction log or other database is updated accordingly. The address label and/or disbursement record are added to the transaction database 250 in the event of correct or incorrect delivery. Administrators can set up notification preferences such that they receive information about where a disbursement was delivered and a budget reference number, thereby assisting them in looking up the proper recipient in the event of failed delivery.

Referring now to FIG. 7, there is shown a flow diagram of an embodiment of the attribution process. Once proper delivery is confirmed by the system, the system is configured to read, by way of the client interface, the disbursement amount off the address label 241, and modify the stored information to add this amount to an available balance 242. The available balance for each department, project and individual employee can be accessed by the system via the client interface. Every time a disbursal is accepted or an expenditure is entered, the system automatically updates the running total. Because attributions are automatically logged by the system in the transaction database 251, any suspected discrepancies in available balance can easily be figured out and addressed without the need for substantial investigation.

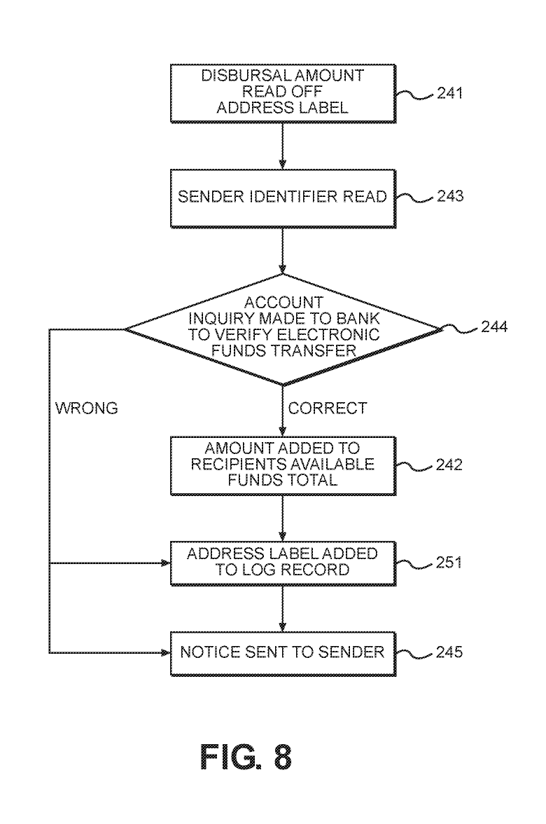

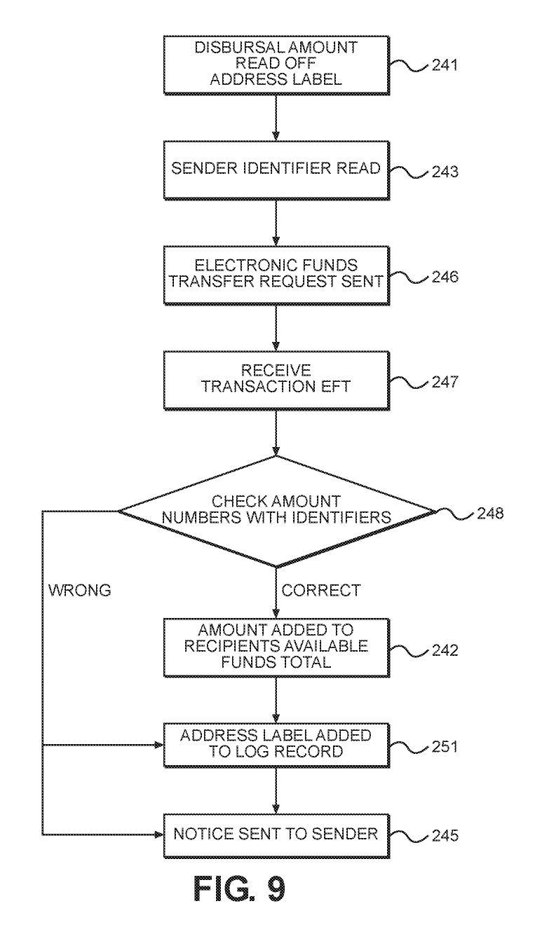

Referring now to FIG. 8, there is shown an embodiment of the attribution process associated with the system in communication with outside financial institutions. As discussed above, the system can be utilized to track a disbursement ending with an electronic funds transfer request for transfer of funds from the sender's bank account to that of the addressee department. The attribution process of FIG. 9 is a continuation of this process. In the shown embodiment, disbursal amount information is read off the address label 241, along with the sender's identifier 243. The system is configured to automatically look up the sender and recipient bank accounts and then request confirmation that the electronic funds transfer did occur between the two accounts 244. This may be in the form of an independent transaction history inquiry to the financial institution or may be an internal inquiry automatically performed by the system. In the case of internal inquiry, the system queries the transaction database for a confirmation code issued by the financial institution regarding the requested transfer. In this embodiment of the invention, it is thus necessary to store EFT request and confirmation information within the transaction database and associate this information with the sender and addressee bank accounts, so that proper verification can easily commence.

If the funds transfer is verified, then the system is configured to update 242 the appropriate available balance. The transaction log is updated 251 and a notice may be sent to the sender 245. Transaction log updates includes information concerning the confirmation code of the electronic funds transfer. In the event that the transfer is not verified, the transaction log is update with the erroneous information and marked as a delivery failure. The sender is immediately notified so that the EFT can be reversed if necessary.

Referring now to FIG. 9, there is shown another alternative embodiment of the funds attribution. After the disbursal amount is read from the address label 241 along with the sender identifier 243, the system is configured to automatically look up the bank account information for both the sender and recipient. An electronic funds transfer request is then sent to the financial institution 246. The request indicates that funds in the amount disclosed on the address label should be moved from the sender's bank account to the addressee's account. An EFT transaction confirmation is then received from the bank 247.

The system is further configured to check the bank accounts associated with the transfer confirmation against the sender and recipient bank account information to ensure proper transfer. If all accounts match, then the system automatically updates 242 the recipient's available balance, and the transaction is logged within the transaction database 251. If the accounts do not match, the available funds balance is not updated and notice is sent to the sender immediately, while the error is recorded in the database 251. Funds transfer information is also transmitted to the sender so that they can reverse the transaction if needed.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation

I claim:

1) A disbursement tracking system, comprising:
a processor;
a non-transitory computer readable medium operatively connected to the processor;
a logic stored in the non-transitory computer readable medium that, when executed by the processor, causes the disbursement tracking system to perform a method, the method comprising:
receiving a disbursal request from an administrator interface, the disbursal request including an address label that includes sender identifier, an addressee identifier, and a disbursal amount;
transmitting the disbursal request to a recipient via a network, the selection of the recipient and the transmission of the disbursal request corresponding to one or more budget parameters stored in the non-transitory computer readable medium;
comparing the addressee identifier to a plurality of recipient identifiers stored in the non-transitory computer readable medium, each recipient identifier corresponding to individual recipients, each individual recipient corresponding to a department in an organization;
if the addressee identifier matches the recipient identifier, then disbursing the disbursal amount to the recipient and modifying the one or more budget parameters based on the disbursal amount;
if the addressee identifier does not match the recipient identifier, then displaying a failed delivery notice on the administrator interface, and storing the failed delivery notice in the non-transitory computer readable medium.

2) The system of claim 1, wherein said disbursal request further comprises a budget proposal reference identifier that is specific to a particular disbursal request.

3) The system of claim 1, wherein confirmed delivery of the disbursal request results in an automatic modification to the recipient identifier, the automatic modification including an increase of available funds balance associated with the stored recipient identifier of the recipient.

4) The system of claim 1, wherein the client interface is configured to receive input regarding expenditures by a department linked to a unique disbursement pool identifier.

5) The system of claim 1, wherein said system is configured to modify the disbursal request after receipt by the recipient to include a second addressee, and wherein the system is configured to transmit the disbursal request to the second addressee.

6) The system of claim 1, wherein a disbursement history is stored in the non-transitory computer readable medium, the disbursement history including notices of failed delivery and notices of completed delivery.
